(19) United States
(12) Patent Application Publication
(10) Pub. No.: US 2013/0243332 A1
(43) Pub. Date: Sep. 19, 2013

(54) Method and System for Estimating an Object of Interest

(71) Applicant: O2 MICRO INC., Santa Clara, CA (US)

(72) Inventors: Sterling Shyundii Du, Shanghai (CN); Jingjing Zuo, Beijing (CN); Chengxia He, Sichuan (CN); Qi Zhu, Chengdu (CN)

(73) Assignee: O2 Micro Inc., Santa Clara, CA (US)

(21) Appl. No.: 13/790,093

(22) Filed: Mar. 8, 2013

(30) Foreign Application Priority Data
Mar. 15, 2012 (CN) 201210068720.2

(51) Int. Cl. G06K 9/00

(52) U.S. Cl. CPC G06K 9/00597
USPC 382/195

(57) ABSTRACT

Method and system for estimating an object of interest are provided. Visual information of a customer's face is obtained. Pupil location information indicative of at least a location of a pupil of an eye of the customer is determined based on the visual information. A field of view of the customer is determined based on the visual information. Then a focal point of the customer is determined based on the pupil location information, the field of view, and a predetermined focus condition. An object of interest of the customer is estimated based on the focal point. Information associated with the object is provided to the customer.

### RELATED APPLICATION

The present application claims priority to Patent Application No. 201210068720.2, filed on Mar. 15, 2012, with the State Intellectual Property Office of the People's Republic of China.

### BACKGROUND

Conventionally, when a customer enters a shopping mall, a clerk steps forward to ask the customer what to buy. However, such behavior usually annoys the customer. Thus, a method and system that is able to detect a product/goods that is interesting to a user in a more implicit manner may help a shop clerk to offer the interesting product/goods and associated sale information in a more effective way.

### SUMMARY

In one embodiment, a method for estimating an object of interest is provided. Visual information of a customer's face is obtained. Pupil location information indicative of at least a location of a pupil of an eye of the customer is determined based on the visual information. A field of view of the customer is determined based on the visual information. Then a focal point of the customer is determined based on the pupil location information, the field of view, and a predetermined focus condition. An object of interest of the customer is estimated based on the focal point. Information associated with the object is provided to the customer.

In another embodiment, an apparatus for estimating an object of interest is provided. The apparatus includes a visual information obtaining module, a pupil location information determining module, a field-of-view determining module, a focal point determining module, and a control module. The visual information obtaining module is configured for obtaining visual information of a customer's face. The pupil location information determining module is configured for determining pupil location information indicative of at least a location of a pupil of an eye of the customer based on the visual information. The field-of-view determining module is configured for determining a field of view of the customer based on the visual information. The focal point determining module is configured for determining a focal point of the customer based on the pupil location information, the field of view of the customer, and a predetermined focus condition. The control module is configured for estimating an object of interest of the customer based on the focal point and providing information associated with the object to the customer.

In yet another embodiment, a system comprising a plurality of sub-systems connected via a network is provided. A first sub-systems of the plurality of sub-systems comprises a visual information obtaining module, a pupil location information determining module, a field-of-view determining module, a focal point determining module, a control module, a collecting module, and a sharing module. The visual information obtaining module is configured for obtaining visual information of a customer's face. The pupil location information determining module is configured for determining pupil location information indicative of at least a location of a pupil of an eye of the customer based on the visual information. The field-of-view determining module is configured for determining a field of view of the customer based on the visual information. The focal point determining module is configured for determining a focal point of the customer based on the pupil location information, the field of view of the customer, and a predetermined focus condition. The control module is configured for estimating an object of interest of the customer based on the focal point and providing information associated with the object to the customer. The collecting module is configured for collecting statistics with respect to the object. The sharing module is configured for facilitating sharing of the statistics with respect to the object among the plurality of sub-systems via the network.

Additional benefits and novel features will be set forth in part in the description which follows, and in part will become apparent to those skilled in the art upon examination of the following and the accompanying drawings or may be learned by production or operation of the disclosed embodiments. The benefits of the present embodiments may be realized and attained by practice or use of various aspects of the methodologies, instrumentalities and combinations set forth in the detailed description set forth below.

### BRIEF DESCRIPTION OF THE DRAWINGS

Features and benefits of embodiments of the claimed subject matter will become apparent as the following detailed description proceeds, and upon reference to the drawings, wherein like numerals depict like parts. These exemplary embodiments are described in detail with reference to the drawings. These embodiments are non-limiting exemplary embodiments, in which like reference numerals represent similar structures throughout the several views of the drawings, and wherein:

FIG. 1 illustrates a flowchart of an exemplary method for estimating an object of interest, in accordance with an embodiment of the present teaching;

FIG. 2 illustrates a flowchart of another exemplary method for estimating an object of interest, in accordance with an embodiment of the present teaching;

FIG. 3 illustrates examples of pupil-movement sub-areas, in accordance with an embodiment of the present teaching;

FIG. 4 illustrates an example of a field of view, in accordance with an embodiment of the present teaching;

FIG. 5 illustrates a block diagram of an example of an apparatus for estimating an object of interest, in accordance with an embodiment of the present teaching;

FIG. 6 illustrates a block diagram of another example of an apparatus for estimating an object of interest, in accordance with an embodiment of the present teaching;

FIG. 7 depicts an exemplary system for estimating an object of interest and sharing statistics with respect to the object, in accordance with an embodiment of the present teaching; and

FIG. 8 depicts a general computer architecture on which the present teaching can be implemented.

### DETAILED DESCRIPTION

Reference will now be made in detail to the embodiments of the present teaching. While the present teaching will be described in conjunction with these embodiments, it will be understood that they are not intended to limit the present teaching to these embodiments. On the contrary, the present teaching is intended to cover alternatives, modifications and equivalents, which may be included within the spirit and scope of the present teaching as defined by the appended claims.

Furthermore, in the following detailed description of the present teaching, numerous specific details are set forth in order to provide a thorough understanding of the present teaching. However, it will be recognized by one of ordinary skill in the art that the present teaching may be practiced without these specific details. In other instances, well known methods, procedures, components, and circuits have not been described in detail as not to unnecessarily obscure aspects of the present teaching.

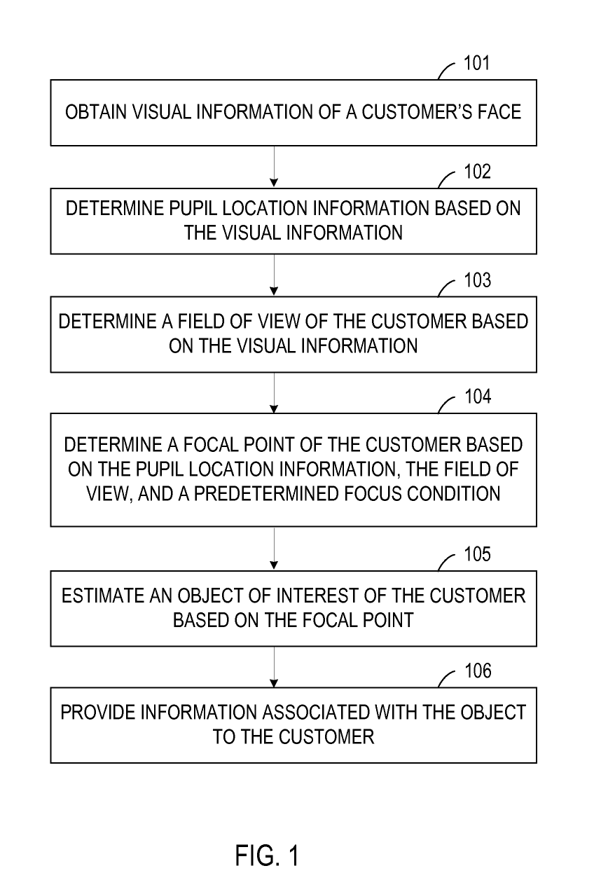

FIG. 1 illustrates a flowchart of an exemplary method for estimating an object of interest, in accordance with an embodiment of the present teaching. The exemplary method may be implemented on a machine having at least one processor, storage, and a communication platform. The present teaching is well suited for performing various variations of the method in FIG. 1.

At 101, visual information of a customer's face may be obtained. The customer may be in a supermarket seeking for a product/goods. The visual information of the customer's face naturally contains visual information of at least an eye of the customer. The visual information may include image information obtained by, e.g., a photo camera or video information obtained by, e.g., a video camera.

At 102, pupil location information may be determined based on the visual information. The pupil location information may indicate at least a location of a pupil of an eye of the customer.

At 103, a field of view of the customer may be determined based on the visual information.

At 104, a focal point of the customer may be determined based on the pupil location information, the field of view of the customer, and a predetermined focus condition. The focal point may be a point, in the field of view, that the customer focuses his/her view at. The predetermined focus condition may be a condition that needs to be met before a focal point of the customer can be affirmed.

At 105, an object may be estimated based on the affirmed focal point. The object may be a product/goods that the customer is interested in.

Then at 106, information associated with the object may be provided to the customer. In case that the object is a product/goods interesting to the customer, the information may include price, features, and/or sales information of the product/goods. The information may be provided by a clerk in person. The information may also be provided by an apparatus via a displaying device in the supermarket or a displaying device with the customer. Thus, the customer can get desirable information associated with a product/goods that may interest him/her, without being disturbed by a clerk.

The method for estimating an object of interest in accordance with an embodiment of the present teaching can be applied in shopping malls, supermarkets, etc. to collect data/information for ordinary customers' interested goods. For example, in accordance with the method shown in FIG. 1, statistics with respect to a goods may be collected. In addition, a level of interest of customers with respect to the goods may be estimated based on the statistics. The statistics and the level of interest of customers with respect to the goods may be shared among multiple entities for enhancing a supply of the goods. The multiple entities may include chain stores of a supermarket selling the goods, manufacturer, supplier, and/or distributor of the goods.

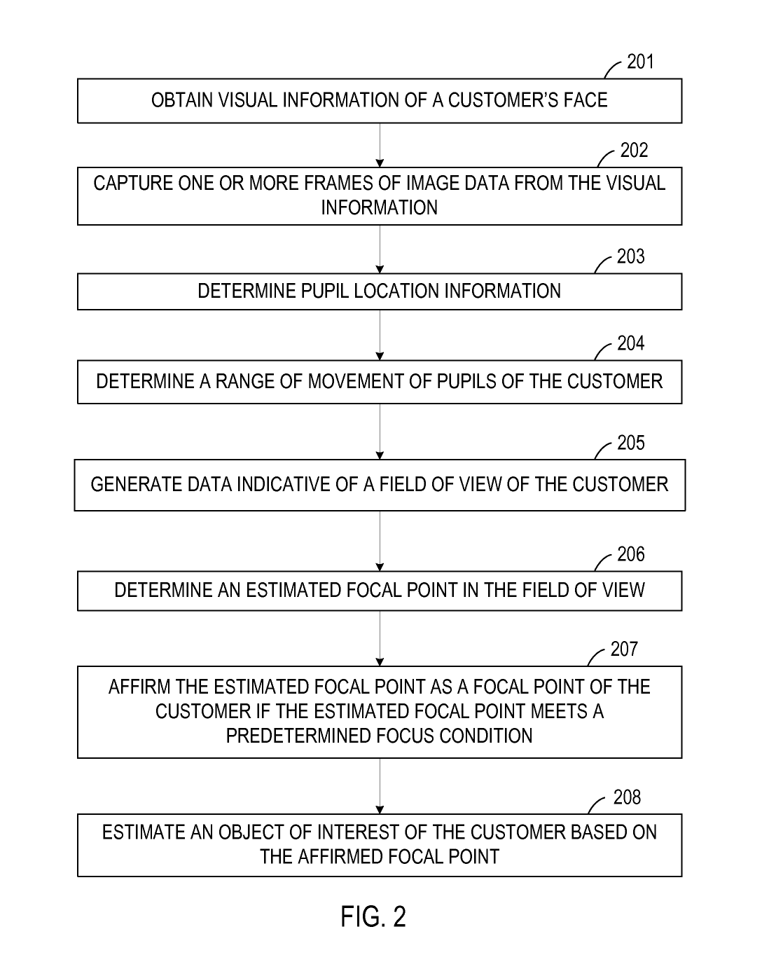

FIG. 2 illustrates a flowchart of another exemplary method for estimating an object of interest, in accordance with an embodiment of the present teaching

At 201, visual information of a customer's face may be obtained.

In one embodiment, the visual information includes one or more frames of image data. In one embodiment, the visual information can be obtained from a video signal of pupils of eyes of the customer via a camera. In an alternate embodiment, in order to reduce computational complexity and amount of information to be stored, a grayscale camera can be used to capture images for the pupils of the eyes. The visual information can also be obtained from another type of camera. For example, an infrared camera can be used to provide the visual information so as to avoid biases caused by light during an image capturing process. Furthermore, both a grayscale camera and an infrared camera can be used together to obtain more accurate visual information.

At 202, one or more frames of image data may be captured from the visual information.

In one embodiment, the images can be processed using a variety of methods, e.g., image compression, image enhancement, image restoration, image segmentation, etc. By processing the images, valid image data can be obtained for analysis. During the image processing, irrelevant image data can be removed. M frames of image data may be captured from the valid image data. M may be a natural number and be greater than or equal to one. For example, M may be six or seven.

At 203, pupil location information of the customer may be determined based on predetermined pupil-movement sub-areas and the captured frames of image data.

Because of a characteristic of eye, e.g., persistence of vision, an afterimage can be persist for about one twenty-fourth of a second on the retina of an eye. Six or seven frames of image data per second can be captured to analyze a movement of a pupil of an eyeball, in one embodiment. Each frame of image data may correspond to a position of the pupil of the eyeball. These six or seven frames of image data may be in a order according to which they were captured, so as to obtain sequential changes of the positions of the pupil.

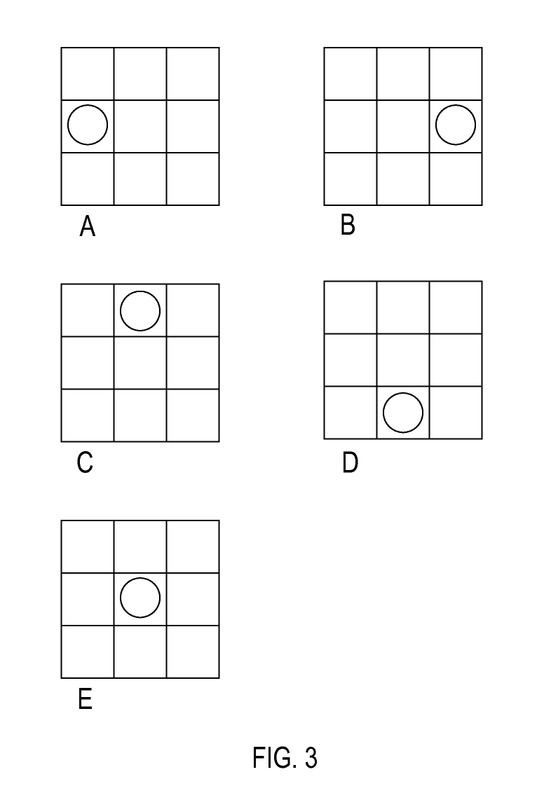

In accordance with an embodiment of the present teaching, location information for both pupils of two eyes of a customer may be determined. Because the process for determining pupil location information may be the same for two pupils, one pupil of one eye will be illustrated and described for example below. As shown in FIG. 3, a human eye area can be, but not necessarily, equally divided into nine sub-areas, in accordance with e.g., the above mentioned predetermined pupil-movement sub-areas. In one embodiment, position A shown in FIG. 3 represents that the pupil of the eyeball is on the left of the image and the eye is looking to the right of the human. Similarly, positions B, C, D, and E respectively represent that the pupil of the eyeball is on the right, the top, the bottom, and the middle of the images in FIG. 3, and respectively represent that the eye is looking to the left, up, down and straight relative to the human. Frames of image data can be mapped to the nine predetermined pupil-movement sub-areas, so as to determine a specific location of the nine sub-areas for the eyeball.

At 204, a range of movement of pupils of the customer may be determined based on the visual information.

Because a radian of rotation of a human eyeball is in a limited range, the range of movement of the pupil in the eyeball can be determined based on the visual information. Thus, a range of movement of both pupils of the customer can be determined accordingly. In one embodiment, the range of movement of the pupil may be indicated by accurate values or values with a permissible deviation.

At 205, a field of view of the customer may be generated based on the range of movement of the pupils. For example, a movement coverage area that covers the range of movement of the pupils can be calculated based on the range of movement. The movement coverage area can be used to define the field of view of the customer.

At 206, an estimated focal point in the field of view of the customer may be determined based on the pupil location information.

In accordance with an embodiment of the present teaching, an estimated focal point is determined based on mapping points in the field of view from both pupils of two eyes of the customer. Because the process for determining mapping points may be the same for two pupils, one pupil of one eye will be illustrated and described for example below. In one embodiment, when a location of the pupil is mapped in the field of view of the customer, the point, representing the location of the pupil, in the field of view is referred to as a mapping point of the location of the pupil (e.g., a point of gaze). In other words, if the location of the pupil is superimposed onto the field of view of the customer, the point, representing the location of the pupil in the field of view of the customer may be the mapping point. The estimated focal point may be determined based on two mapping points of both pupils of the customer. For example, the estimated focal point can be the middle point of the two mapping points in the field of view.

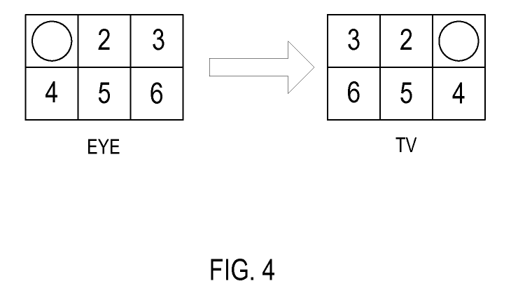

Taking a television (TV) screen as an example of the field of view of an eye ball, a process is described in accordance with FIG. 4 to obtain a location of attention of a person's eye that falls on the TV screen. The location of attention may be indicated by a focal point of the customer. FIG. 4 illustrates an example of a field of view, in accordance with an embodiment of the present teaching. As shown at the left side (e.g., the EYE side) of FIG. 4, a movement coverage area of the pupil of the eye as discussed above may be divided into six pupil-movement sub-areas. At the right side (e.g., the TV side) of FIG. 4, the field of view of the customer may be divided into six sub-areas after being calibrated. Since the person and the TV are face to face, a position of the pupil of the eyeball in the movement coverage area and a location of attention, e.g., a focal point, of the person's eye that falls on the TV screen, are in a mirror relationship. For example, position 1 (represented by a circle) of the pupil on the EYE side of FIG. 4 indicates that the corresponding position 1 (represented by a circle) on the TV side is where the attention is located. If the pupil is on position 6 on the EYE side, the person's attention may fall on position 6 of the TV side. Although the field of view of the customer is divided into six sub-areas in FIG. 4, the teaching is not so limited. In another embodiment, the field of view of the customer can be divided into an arbitrary number of sub-areas. For example, the field of view of the customer can be divided into nine sub-areas as disclosed in FIG. 3, or can be roughly divided into four sub-areas to reduce computational complexity and the amount of information to be stored in storage. Furthermore, the field of view of the customer may or may not be divided equally.

At 207, the estimated focal point may be affirmed as the focal point of the customer if the estimated focal point meets a predetermined focus condition.

In one embodiment, the predetermined focus condition includes a predetermined time condition, and/or a predetermined frequency condition.

The predetermined time condition may be met if the estimated focal point stays in a sub-area in the field of view of the customer for at least a predetermined time period. For example, a predetermined time period may be set to be three seconds. An estimated focal can be affirmed as a focal point if a residence time of the estimated focal point in the field of view of the customer is three seconds or more. In other words, a sub-area in the field of view of the customer may be defined as a focal point if the estimated focal point stays in the sub-area for at least three seconds.

The predetermined frequency condition may be met if the estimated focal point falls in a sub-area at a frequency that is greater than a predetermined frequency threshold. For example, a predetermined frequency threshold may be set to be two times/min. An estimated focal point can be affirmed as a focal point if the estimated focal point in the field of view of the customer appears more than two times in one minute. In other words, a sub-area in the field of view of the customer can be defined as a focal point if the estimated focal point falls in the sub-area at a frequency that is greater than two times per minute.

At 208, an object of interest of the customer may be estimated based on the affirmed focal point. In addition, information associated with the object may be provided to the customer (not shown in FIG. 2).

The method for estimating an object of interest, in accordance with an embodiment of the present teaching can be applied in many places, e.g., shopping malls, supermarkets, etc. It is important and desirable to understand demands of customers in many places. The conventional way that a clerk steps forward to ask a customer is often considered as a disturb to the customer. Therefore, an eyeball movement tracking system implementing an exemplary method of the present teaching can be applied in the shopping malls to avoid disturbing the customers, and also can obtain information for the customers' shopping demands conveniently and accurately. Furthermore, the method of the present teaching can also be used to provide goods information corresponding to the focal point, e.g., styles, prices, discounts of the goods, and information about whether there are updated and new arrivals of the goods, to registered users. The registered users may be, e.g., registered customers of a supermarket, a shopping mall, or other places. If a customer is not a registered user, the eyeball movement tracking system may capture and collect information with respect to the focal point of the customer.

In one embodiment, if a registered user (or a registered account) is bound to a specific terminal, the related information for the goods may be transmitted to the specific terminal. In one embodiment, the specific terminal may be a customer-held terminal, e.g., a portable computer, mobile phone, or other receiving devices.

In one embodiment, a customer can become a registered user of a store by downloading related application software provided by the store to a customer-held terminal and registering to be a member of a service that provides goods information. It can be determined that whether a customer is a registered user by a comparison of obtained visual information of the customer with stored visual information of registered users, or by recognizing an identity of the customer using an ID (identification) device.

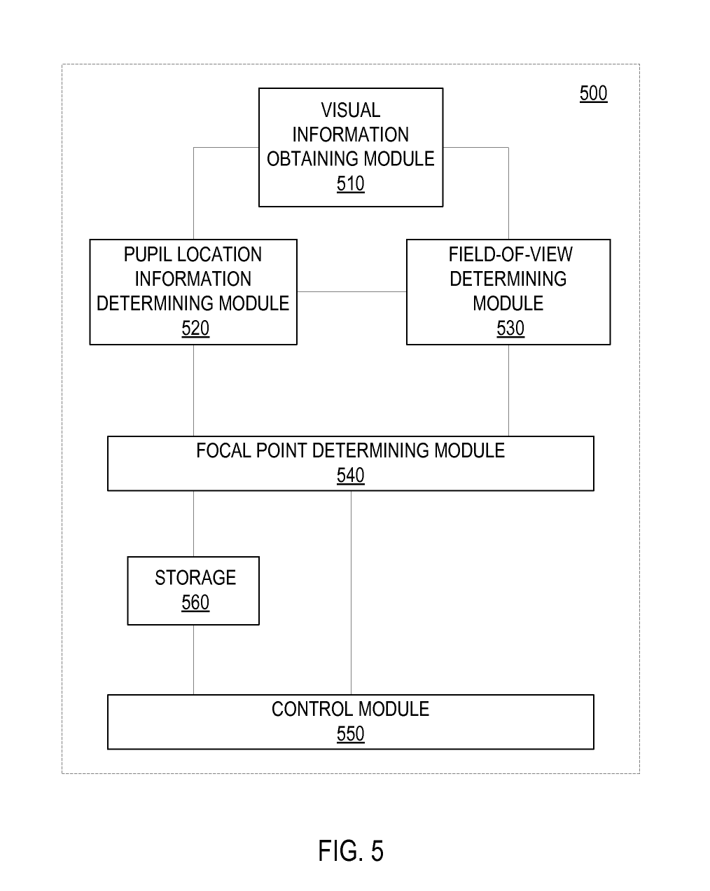

FIG. 5 illustrates a block diagram of an example of an apparatus 500 for estimating an object of interest, in accordance with an embodiment of the present teaching. The apparatus 500 may have at least one processor, storage, and a communication platform. The apparatus 500 in the exemplary embodiment includes a visual information obtaining module 510, a pupil location information determining module 520, a field-of-view determining module 530, a focal point determining module 540, a control module 550 and a storage 560.

The visual information obtaining module 510 may obtain visual information of a customer's face, which naturally includes one or two eyeballs.

The pupil location information determining module 520 may determine pupil location information indicative of at least a location of a pupil of an eyeball based on the visual information.

The field-of-view determining module 530 may determine a field of view of the customer based on the visual information.

The focal point determining module 540 may determine a focal point based on the pupil location information, the field of view of the customer, and a predetermined focus condition.

The control module 550 may estimate an object of interest of the customer based on the focal point and provide information associated with the object to the customer.

The storage 560 may store the predetermined focus condition and/or the information associated with the object.

The predetermined focus condition may include a predetermined time condition, and/or a predetermined frequency condition.

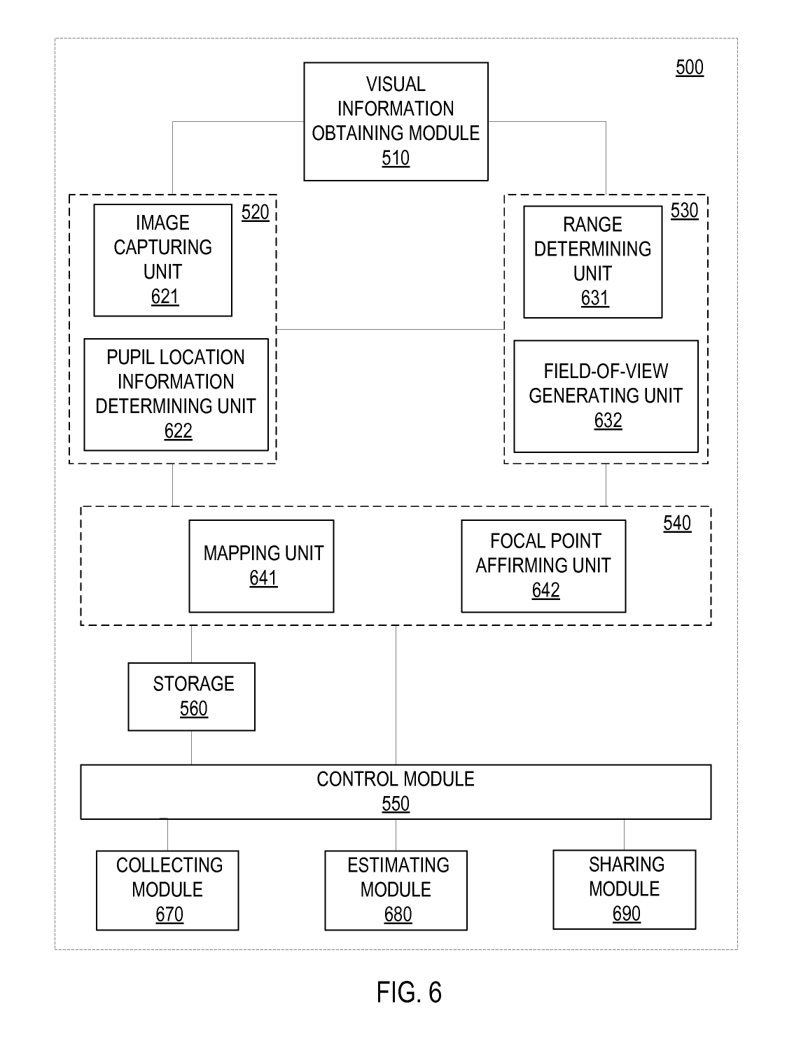

FIG. 6 illustrates a block diagram of another example of an apparatus 500 for estimating an object of interest, in accordance with an embodiment of the present teaching.

The pupil location information determining module 520 may further include an image capturing unit 621 that captures one or more frames of image data from the visual information, and include a pupil location information determining unit 622 that determines pupil location information for at least a pupil of an eyeball based on predetermined pupil-movement sub-areas and the frames of image data. In one embodiment, the frames of image data includes at least six frames of image data.

The field-of-view determining module 530 may further include a range determining unit 631 that determines a range of movement of the pupils based on the visual information, and include a field-of-view generating unit 632 that generates data indicative of the field of view of the customer based on the range of the movement of the pupils.

The focal point determining module 540 may further include a mapping unit 641 that determines an estimated focal point in the field of view of the customer based on the pupil location information, and include a focal point affirming unit 642 that affirms an estimated focal point as a focal point of the customer if the estimated focal point meets the above mentioned predetermined focus condition.

The apparatus 500, in the exemplary embodiment shown in FIG. 6, may further include a collecting module 670, an estimating module 680, and/or a sharing module 690.

The collecting module 670 may be configured for collecting statistics with respect to the object of interest.

The estimating module 680 may be configured for estimating a level of interest of customers with respect to the object based on the statistics with respect to the object.

The sharing module 690 may be configured for sharing the statistics with respect to the object among multiple entities for enhancing a supply of the object. When the object is a goods interesting to the customer, the multiple entities may include chain stores of a supermarket selling the goods, manufacturers of the goods, suppliers of the goods, and/or distributors of the goods. The multiple entities may be connected via a local area network or Internet.

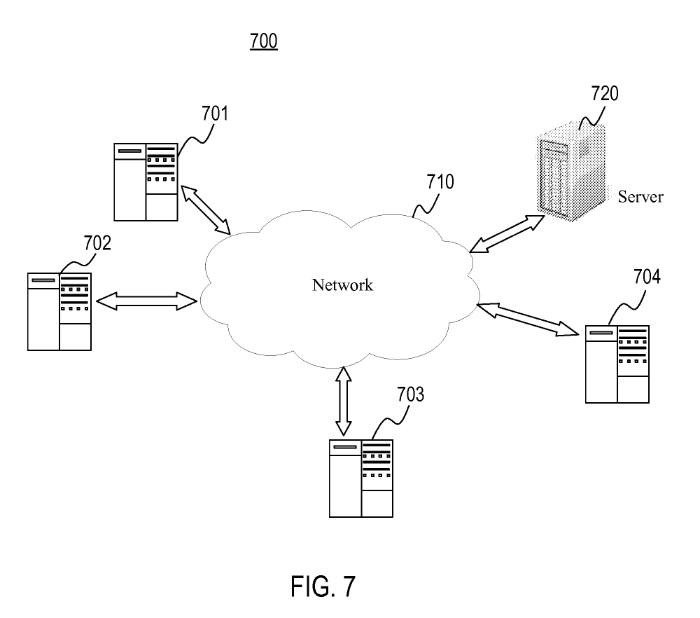

FIG. 7 depicts an exemplary system 700 for estimating an object of interest and sharing statistics with respect to the object, in accordance with an embodiment of the present teaching. The system 700 may include multiple sub-systems 701, 702, 703, 704, connected via a network 710.

In the exemplary embodiment, at least one of the multiple sub-systems includes all modules in the apparatus 500, as shown in FIG. 5 or FIG. 6. For example, sub-system 701 in the system 700 can determine a focal point of a customer, estimate an object of interest of the customer based on the focal point, and collect data or statistics with respect to the estimated object.

In addition, the sub-system 701 may facilitate sharing of the statistics with respect to the object among the multiple sub-systems 701, 702, 703, 704 in the system 700, via the network 710. In one embodiment, the system 700 further comprises a server 720 connected to the network 710. The server 720 may be configured for controlling the sharing of the statistics among the sub-systems 701, 702, 703, 704 in the system 700. For example, the server 720 may receive the statistics with respect to the object from the sub-system 701 and provide the statistics to other sub-systems 702, 703, 704 in the system 700.

The network 710 may be a local area network or Internet. Each of the sub-systems 701, 702, 703, 704 may be located in an entity that is associated with the object. When the object is a goods interesting to the customer, statistics of the goods can be shared among the entities for enhancing a supply of the goods.

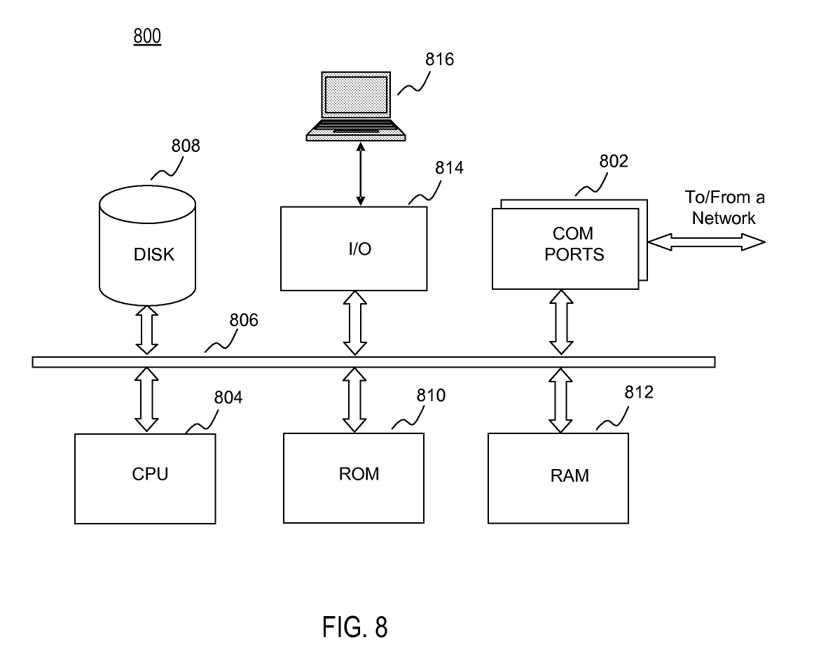

FIG. 8 depicts a general computer architecture on which the present teaching can be implemented and has a functional block diagram illustration of a computer hardware platform that includes user interface elements. The computer may be a general-purpose computer or a special purpose computer. This computer 800 can be used to implement any components of the system as described herein for estimating an object of interest and sharing statistics with respect to the object. Different components of the system 700 as depicted in FIG. 7, can all be implemented on one or more computers such as computer 800, via its hardware, software program, firmware, or a combination thereof. Although only one such computer is shown, for convenience, the computer functions relating to dynamic relation and event detection may be implemented in a distributed fashion on a number of similar platforms, to distribute the processing load.

The computer 800, for example, includes COM ports 802 connected to and from a network connected thereto to facilitate data communications. The computer 800 also includes a central processing unit (CPU) 804, in the form of one or more processors, for executing program instructions. The exemplary computer platform includes an internal communication bus 806, program storage and data storage of different forms, e.g., disk 808, read only memory (ROM) 810, or random access memory (RAM) 812, for various data files to be processed and/or communicated by the computer, as well as possibly program instructions to be executed by the CPU. The computer 800 also includes an I/O component 814, supporting input/output flows between the computer and other components therein such as user interface elements 816. The computer 800 may also receive programming and data via network communications.

Hence, aspects of the method of estimating an object of interest, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present teachings are amenable to a variety of modifications and/or enhancements. For example, although the implementation of various components described above may be embodied in a hardware device, it can also be implemented as a software only solution—e.g., an installation on an existing server. In addition, the units of the host and the client nodes as disclosed herein can be implemented as a firmware, firmware/software combination, firmware/hardware combination, or a hardware/firmware/software combination.

While the foregoing description and drawings represent embodiments of the present teaching, it will be understood that various additions, modifications and substitutions may be made therein without departing from the spirit and scope of the principles of the present teaching as defined in the accompanying claims. One skilled in the art will appreciate that the teaching may be used with many modifications of form, structure, arrangement, proportions, materials, elements, and components and otherwise, used in the practice of the teaching, which are particularly adapted to specific environments and operative requirements without departing from the principles of the present teaching. The presently disclosed embodiments are therefore to be considered in all respects as illustrative and not restrictive, the scope of the teaching being indicated by the appended claims and their legal equivalents, and not limited to the foregoing description.

What is claimed is:

1. A method, implemented on a machine having at least one processor, storage, and a communication platform, comprising:
obtaining visual information of a customer's face;
determining pupil location information indicative of at least a location of a pupil of an eye of the customer based on the visual information;
determining a field of view of the customer based on the visual information;
determining a focal point of the customer based on the pupil location information, the field of view of the customer, and a predetermined focus condition;
estimating an object of interest of the customer based on the focal point; and
providing information associated with the object to the customer.

2. The method as claimed in claim 1, wherein determining the pupil location information comprises:
capturing one or more frames of image data from the visual information; and
determining the pupil location information based on a plurality of predetermined pupil-movement sub-areas and the one or more frames of image data.

3. The method as claimed in claim 1, wherein determining the field of view of the customer comprises:
determining a range of movement of the pupil based on the visual information; and
generating data indicative of the field of view of the customer based on the range of movement of the pupil.

4. The method as claimed in claim 1, wherein determining the focal point of the customer comprises:
determining an estimated focal point in the field of view of the customer based on the pupil location information; and
affirming the estimated focal point as the focal point of the customer if the estimated focal point meets the predetermined focus condition.

5. The method as claimed in claim 1, further comprising:
collecting statistics with respect to the object.

6. The method as claimed in claim 5, further comprising:
estimating a level of interest of customers with respect to the object based on the statistics with respect to the object; and
sharing the statistics with respect to the object among multiple entities for enhancing a supply of the object.

7. The method as claimed in claim 1, wherein:
the predetermined focus condition comprises at least one condition of a predetermined time condition and a predetermined frequency condition,
the predetermined time condition is met if the focal point stays in a sub-area in the field of view for at least a predetermined time period, and
the predetermined frequency condition is met if the focal point falls in a sub-area at a frequency that is greater than a predetermined frequency threshold.

8. An apparatus having at least one processor, storage, and a communication platform, comprising:
a visual information obtaining module implemented on the processor and configured for obtaining visual information of a customer's face;
a pupil location information determining module implemented on the processor and configured for determining pupil location information indicative of at least a location of a pupil of an eye of the customer based on the visual information;
a field-of-view determining module implemented on the processor and configured for determining a field of view of the customer based on the visual information;
a focal point determining module implemented on the processor and configured for determining a focal point of the customer based on the pupil location information, the field of view of the customer, and a predetermined focus condition stored in the storage; and
a control module implemented on the processor and configured for estimating an object of interest of the customer based on the focal point and providing information associated with the object to the customer.

9. The apparatus as claimed in claim 8, wherein the pupil location information determining module comprises:
an image capturing unit configured for capturing one or more frames of image data from the visual information; and
a pupil location information determining unit configured for determining the pupil location information based on a plurality of predetermined pupil-movement sub-areas and the one or more frames of image data.

10. The apparatus as claimed in claim 8, wherein the field-of-view determining module comprises:
a range determining unit configured for determining a range of movement of the pupil based on the visual information; and
a field-of-view generating unit configured for generating data indicative of the field of view of the customer based on the range of movement of the pupil.

11. The apparatus as claimed in claim 8, wherein the focal point determining module comprises:
a mapping unit configured for determining an estimated focal point in the field of view of the customer based on the pupil location information; and
a focal point affirming unit configured for affirming the estimated focal point as the focal point of the customer if the estimated focal point meets the predetermined focus condition.

12. The apparatus as claimed in claim 8, wherein the apparatus further comprises:
a collecting module configured for collecting statistics with respect to the object.

13. The apparatus as claimed in claim 12, wherein the apparatus further comprises:
an estimating module configured for estimating a level of interest of customers with respect to the object based on the statistics with respect to the object; and
a sharing module configured for sharing the statistics with respect to the object among multiple entities for enhancing a supply of the object.

14. The apparatus as claimed in claim 8, wherein:
the predetermined focus condition comprises at least one condition of a predetermined time condition and a predetermined frequency condition,
the predetermined time condition is met if the focal point stays in a sub-area in the field of view for at least a predetermined time period, and
the predetermined frequency condition is met if the focal point falls in a sub-area at a frequency that is greater than a predetermined frequency threshold.

15. A system comprising a plurality of sub-systems connected via a network, wherein:
each of the plurality of sub-systems has at least one processor, storage and a communication platform connected to the network, and
a first sub-system of the plurality of sub-systems comprises:
a visual information obtaining module configured for obtaining visual information of a customer's face;
a pupil location information determining module configured for determining pupil location information indicative of at least a location of a pupil of an eye of the customer based on the visual information;
a field-of-view determining module configured for determining a field of view of the customer based on the visual information;
a focal point determining module configured for determining a focal point of the customer based on the pupil location information, the field of view of the customer, and a predetermined focus condition stored in the storage;
a control module configured for estimating an object of interest of the customer based on the focal point and providing information associated with the object to the customer;
a collecting module configured for collecting statistics with respect to the object; and
a sharing module configured for facilitating sharing of the statistics with respect to the object among the plurality of sub-systems via the network.

16. The system as claimed in claim 15, further comprising a server connected to the network, wherein the server is configured for controlling the sharing of the statistics with respect to the object by receiving the statistics with respect to the object from the first sub-system and providing the statistics with respect to the object to other sub-systems in the system.

17. The system as claimed in claim 15, wherein the pupil location information determining module comprises:
an image capturing unit configured for capturing one or more frames of image data from the visual information; and
a pupil location information determining unit configured for determining the pupil location information based on a plurality of predetermined pupil-movement sub-areas and the one or more frames of image data.

18. The system as claimed in claim 15, wherein the field-of-view determining module comprises:
a range determining unit configured for determining a range of movement of the pupil based on the visual information; and
a field-of-view generating unit configured for generating data indicative of the field of view of the customer based on the range of movement of the pupil.

19. The system as claimed in claim 15, wherein the focal point determining module comprises:
a mapping unit configured for determining an estimated focal point in the field of view of the customer based on the pupil location information; and
a focal point affirming unit configured for affirming the estimated focal point as the focal point of the customer if the estimated focal point meets the predetermined focus condition.

20. The system as claimed in claim 15, wherein the first sub-system further comprises an estimating module configured for estimating a level of interest of customers with respect to the object based on the statistics with respect to the object.
